(19) United States
(12) Patent Application Publication
(10) Pub. No.: US 2022/0404187 A1
(43) Pub. Date: Dec. 22, 2022

(54) SMART HYDRATION RESERVOIR AND ALGORITHM OF CALCULATING THE LIQUID LEVEL THEREOF

(71) Applicant: Man Yin Arthur Newton CHU, Chai Wan (HK)

(72) Inventor: Man Yin Arthur Newton CHU, Chai Wan (HK)

(21) Appl. No.: 17/349,521

(22) Filed: Jun. 16, 2021

(51) Int. Cl. G01F 23/26; A45F 3/20

(52) U.S. Cl. CPC G01F 23/268; G01F 23/266; A45F 3/20; A45F 2003/166

(57) ABSTRACT

A smart hydration reservoir includes a flexible sensor which can be attached to the outer surface of any kind of the hydration reservoir and monitor changes of capacitive data of the hydration reservoir while user drinks the liquid which makes changes of the liquid level. The capacitive data is inputted into the controller; the controller will calculate the liquid level and then send out the information of the liquid level to the hand held device, such as specified display or mobile phone. Thus, the user can easily notice the liquid level of the hydration reservoir. The whole hydration detecting assembly can be easily installed to any hydration reservoir bought from the market.

### FIELD OF THE INVENTION

The present invention relates generally to hydration reservoirs, and more specifically to hydration reservoirs with liquid level detection.

### BACKGROUND OF THE INVENTION

Hydration reservoir is commonly used for outdoor recreational activities, such as hiking, bicycling, and kayaking, as well as for military maneuvers. The hydration reservoir is a type of hydration system containing a reservoir or “bladder” commonly made of rubber or flexible plastic. The reservoir contains a capped mouth for refilling with liquid and a hose that allows the wearer to drink hands-free. Most hoses end with a “bite valve” that opens when the user bites down on it. The valve may be protected by a dust cover.

Generally, the hydration reservoir is placed in the backpack or waistpack for user to easily carry. During exercising, user cannot know about remain amount of liquid. Now they can only take out the hydration reservoir to look into, which is not reasonable during the competition, especially for marathon, hiking and bicycling.

### SUMMARY OF THE INVENTION

In view of the aforesaid drawbacks of the prior art, the present invention provides a smart hydration reservoir, user can easily notice the liquid level of the smart hydration reservoir.

Also, the present invention provides an algorithm of calculating the liquid level of the smart hydration reservoir.

Smart hydration reservoir comprises a flexible hydration bladder for storing a liquid; a flexible sensor is attached to the hydration bladder for measuring the level of the liquid inside; the sensor is connected to a controller which collects the data from the senor and calculates the liquid level; the controller is provide with at least a wireless transfer module to send the liquid level to a receiving device for displaying the liquid level.

Furthermore, the flexible sensor is a capacitive sensor which is printed on the FPC.

Furthermore, the controller is embedded in a control box and the flexible sensor is extending from the control box, the control box and the flexible sensor is united as a hydration detecting assembly which is attached to the outer surface of the hydration bladder.

Furthermore, the capacitive sensor includes several capacitive pads tilt arranges along the FPC.

Furthermore, the receiving device is a key fob, which is provided with at least a control board, a display for displaying the liquid level and a wireless receive module for communicating with the wireless transfer module.

Furthermore, the receiving device is a mobile phone/a tablet computer, which is installed with apps for controlling the wireless module of the mobile phone to communicating with the wireless transfer module and displaying the liquid level on the screen.

Furthermore, the wireless transfer module/the wireless receive module/the wireless module can be Wifi module, Blue Tooth module, or RF module.

Furthermore, the mart hydration reservoir comprises a rigid bladder protector, and the hydration bladder is put into the bladder protector to prevent the hydration bladder from squeezing.

Algorithm of calculating the liquid level of the smart hydration reservoir of claim 2, the flexible sensor detect the capacitance data of the hydration bladder and the capacitance data is inputted into the I/O of the controller for calculating the liquid level; calibration: the liquid of series settings of liquid level is filled into the hydration bladder and the controller calculates the corresponding capacitance data and stores it in to a database with the liquid level data; measurement of liquid level: the flexible sensor detect the capacitance data of the hydration bladder in real time, the controller reads the capacitance data of the database and compare it with the real time capacitance data to get the corresponding liquid level date of database as the liquid level of the hydration bladder.

The invention has the following advantages: The flexible sensor can be attached to the outer surface of any kind of the hydration reservoir. It can monitor changes of capacitive data of the hydration reservoir while user drinks the liquid which makes changes of the liquid level. The capacitive data is inputted into the controller; the controller will calculate the liquid level and then send out the information of the liquid level to the hand held device, such as specified display or mobile phone. So that user can easily notice the liquid level of the hydration reservoir. The whole hydration detecting assembly can be easily installed to any hydration reservoir bought from the market.

### BRIEF DESCRIPTION OF THE DRAWINGS

Below are explanations of the invention combining with drawings.

FIG. 1 is the front view of the present invention.

FIG. 2 is the perspective view of the bladder protector.

FIG. 3 is the perspective view of the key fob.

In the figures: 1. the hydration bladder, 2. the flexible sensor, 3. the control box, 4. the key fob, 5. the display, 6. the bladder protector, 7. the capacitive pads.

### DESCRIPTION OF THE EMBODIMENTS

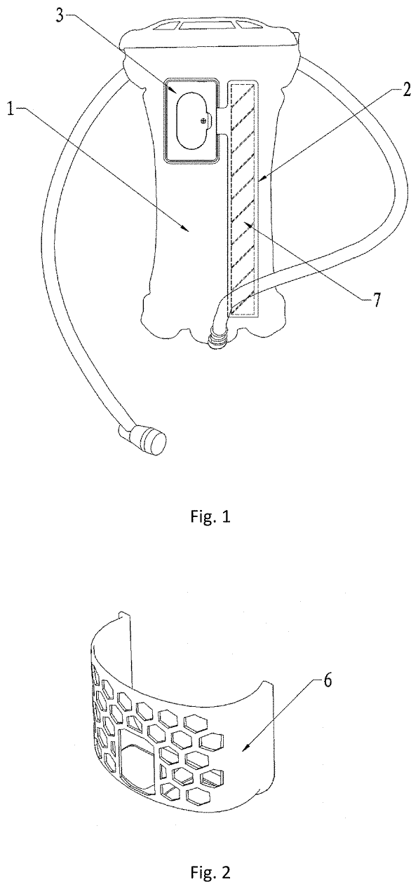

Refer to Fig. 1, Smart hydration reservoir comprises a flexible hydration bladder 1 for storing a liquid. The hydration bladder 1 is made of rubber or flexible plastic. There is opening on the top for water refilling and a hose on the bottom which extends outside the backpack. A mouthpiece with bite-valve is set at the end of the hose which user just bites to suck water and prevent leakage. The flexible sensor 2 is attached to the hydration bladder 1 without any damage to the hydration bladder 1. So that it can adapt to most of the hydration reservoir in the market and add-on the flexible sensor 2 for monitoring the liquid level.

The hydration bladder 1 can be regard as a capacitor. The capacitance of the hydration bladder 1 changes with the liquid level. So using a capacitive sensor to detect the level is feasible. In this invention, the inventor provides a capacitive sensor which is printed on the FPC as the flexible sensor 2. The capacitive sensor includes several capacitive pads 7 and each capacitive cap connects to the I/O of controller. These capacitive pads 7 are printed on the FPC and they are tilt arranges. Especially, each the capacitive pad is designed as parallelogram so that the level will be detected by at least two pads 7 next together to improve the accuracy of the capacitive sensor.

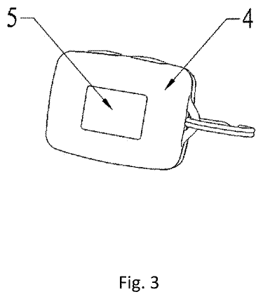

In order to facilitate the device onto the hydration bladder 1, the controller is embedded in a control box 3 and the flexible sensor 2 is extending from the control box 3, the control box 3 and the flexible sensor 2 is united as a hydration detecting assembly which is attached to the outer surface of the hydration bladder 1. The controller may use MCU as processor for calculation. The controller can embed with a wireless transfer module or connect to an external wireless transfer module. Then the user can hold a receiving device which connect with the wireless transfer module and display the liquid level. Said wireless transfer module or receiving device can be one of below: Wifi module, Blue Tooth module, or RF module. Refer to Fig. 3, the receiving device can be a specific key fob 4, including a control board, a display 5. User can put it in the pocket and when necessary, he takes out and just light up the display 5 to show off the level of liquid inside the hydration bladder 1. Or the receiving device can be a mobile phone/a tablet computer. It is installed with apps for controlling the wireless module of the mobile phone to communicating with the wireless transfer module, also dealing with data which is sent from the wireless transfer module and finally displaying the liquid level on the screen. So user can easily get the information of liquid level without taking out the hydration bladder 1 from the backpack.

Because the hydration bladder 1 commonly made of rubber or flexible plastic and it is possibly squeezed to change the liquid level to send out wrong information to the user, in order to prevent from squeezing the hydration bladder 1, a rigid bladder protector 6 is provided to protect he hydration bladder 1, refer to FIG. 2. The rigid bladder protector 6 is fixed inside the backpack and the hydration bladder 1 is placed inside. And there is a hole set in the protector 6 to let the hose can come out from it.

As we know, the liquid level changes nonlinearly with the decrease in liquid volume due to the elastic material of the hydration bladder 1. So it is hard to accurately calculate of liquid level. And the inventor set up an algorithm of calculating the liquid level for the smart hydration reservoir. Due to different volume and physical properties of different hydration bladders, we must calibrate the hydration bladder 1 first:

1. Attach the FPC with capacitive sensor to the surface of the hydration bladder 1.

2. Fill the hydration bladder 1 with series liquid levels, the controller calculates the corresponding capacitance data and stores it in to a database with the liquid level data. More liquid level data will achieve more accuracy in use.

After calibration, the controller can measure liquid level as follow: the flexible sensor 2 detect the capacitance data of the hydration bladder 1 in real time, the controller reads the capacitance data of the database and compare it with the real time capacitance data to get the corresponding liquid level date of database as the liquid level of the hydration bladder 1. Then the controller sends out information of the liquid level to the receiving device for display.

1. A smart hydration reservoir, comprising:
a flexible hydration bladder for storing a liquid; and
a flexible sensor is attached to the hydration bladder for measuring the level of the liquid inside;
wherein the flexible sensor is connected to a controller which collects the data from the senor and calculates the liquid level;
wherein the controller is provide with at least a wireless transfer module to send the liquid level to a receiving device for displaying the liquid level.

2. The smart hydration reservoir of claim 1, wherein the flexible sensor is a capacitive sensor which is printed on the FPC.

3. The smart hydration reservoir of claim 1, wherein the controller is embedded in a control box and the flexible sensor is extending from the control box, the control box and the flexible sensor is united as a hydration detecting assembly which is attached to the outer surface of the hydration bladder.

4. The smart hydration reservoir of claim 2, wherein the capacitive sensor includes several capacitive pads tilt arranges along the FPC.

5. The smart hydration reservoir of claim 1, wherein the receiving device is a key fob, which is provided with at least a control board, a display for displaying the liquid level and a wireless receive module for communicating with the wireless transfer module.

6. The smart hydration reservoir of claim 1, wherein the receiving device is a mobile phone/a tablet computer, which is installed with apps for controlling the wireless module of the mobile phone to communicating with the wireless transfer module and displaying the liquid level on the screen.

7. The smart hydration reservoir of claim 1, wherein the wireless transfer module/the wireless receive module/the wireless module can be Wifi module, Blue Tooth module, or RF module.

8. The smart hydration reservoir of claim 1, wherein comprising a rigid bladder protector, and the hydration bladder is put into the bladder protector to prevent the hydration bladder from squeezing.

9. An algorithm of calculating the liquid level of the smart hydration reservoir of claim 2, wherein the flexible sensor detects the capacitance data of the hydration bladder and the capacitance data is inputted into the I/O of the controller for calculating the liquid level; the algorithm comprising:
calibration: the liquid of series settings of liquid level is filled into the hydration bladder and the controller calculates the corresponding capacitance data and stores it in to a database with the liquid level data;
measurement of liquid level: the flexible sensor detect the capacitance data of the hydration bladder in real time, the controller reads the capacitance data of the database and compare it with the real time capacitance data to get the corresponding liquid level date of database as the liquid level of the hydration bladder.
